(19) United States
(12) Patent Application Publication
(10) Pub. No.: US 2005/0108144 A1
(43) Pub. Date: May 19, 2005

(54) Wish list auctions

(76) Inventors: Robert Longman, Chicago, IL (US); Sophia C. Li, Chicago, IL (US)

Correspondence Address: ATTN: ROBERT LONGMAN;SMART AUCTIONS, INC., UNIT #145, 1749 GOLF ROAD, MOUNT PROSPECT, IL, 60056, US

(21) Appl. No.: 10/716,909

(22) Filed: Nov. 19, 2003

(51) Int. Cl. G06F 17/60

(52) U.S. Cl. 705/37

(57) ABSTRACT

The present invention provides a new method and system for conducting sealed offer online auctions. Unlike traditional auctions where buyers bid on sellers' items, wish list auction allows buyers to post online listings and attracts sellers to place item offers tailored to the buyers' needs. In a wish list auction, buyers need only to post what they are searching for, and the sellers will place a sealed offer containing information about the respective items they possess, such as prices, detailed descriptions, pictures, and transaction terms. If the buyer find any fitting offers, he/she will either accept the offering price or to make a counter offer to the seller. The seller in turn can either accept or decline a counter offer from the buyer. The winner of a wish list auction can be greater than one since buyer can accept multiple offerings from multiple sellers. Since buyers are spared of searching duty, sellers are freed from fee charges due to online auction providers, as in all cases of traditional online auctions. Instead, buyers are required to pay for service costs to the online auction provider based on the number of offers transacted in each wish list auction.

### FIELD OF INVENTION

The invention relates to auctions and more particularly to online auctions for goods and services.

### BACKGROUD

Online auctions are the most perceptible phenomenon during the 90's dotcom wave. Although methods of online auctions vary from each auction provider, every online auction method has one key feature in common—buyers bear the burden of searching goods and services that are auctioned by sellers. A similar item on eBay.com sold three years ago can only be sold for less than half of the original price these days. Such observation is explained by the unbalanced growth between the number of sellers and the number of buyers in the network. As more and more sellers join the game, searching becomes a more challenging and problematic task for buyers. Participating in antique auctions requires excess resources beyond the basic costs of living. Time spent in online auctions is indeed indisputable opportunity costs for working professionals. Opportunity costs amplify as the compensations for buyers climb. It is reasonable to say that frequent buyers in online auctions are restricted by the amount of time they can involve in. Thus, it is practical to introduce a new way of online auctions, where sellers will take the burden of searching to meet buyers' demands, and the buyers are given the options to post what they are looking in exchange for a small services costs, which are estimated far less than the opportunity costs of searching the entire network of auctions.

Wish List is a common term used to define what buyers desire for. However, there was never a method devoted to minimize or eliminate buyers' searching load. Some online auction providers contain an email system, where buyers will be notified if there are new items in the network that fit buyers' so called “Favorite Item”. Nevertheless, “Favorite Item” function produces only the poorest result since the function merely matches auction item headlines with favorite item headlines. Detailed descriptions are not taken into account for the matching process. Furthermore, online auction costs are becoming increasingly more expensive for sellers. Regardless whether an item is sold or not, sellers are charged with listing fees, which are elevated by the opening prices of the items. With no guarantee to a successful sale, sellers become reluctant to engage in more listings in order to avoid listing fees.

Recognizing this growing need for reduction in search costs for buyers and need for reduction in pre and post auction fees for sellers, we feel the present invention conveys the best and freshest way to match what both buyers and sellers are longing for.

### SUMMARY OF THE INVENTION

The present invention provides a new method and system for conducting sealed offer online auctions. Unlike traditional auctions where buyers bid on sellers' items, wish list auction allows buyers to post online listings and attracts sellers to place item offers tailored to the buyers' needs. In a wish list auction, buyers need only to post what they are searching for, and the sellers will place a sealed offer containing information about the respective items they possess, such as prices, detailed descriptions, pictures, and transaction terms. If the buyer find any fitting offers, he/she will either accept the offering price or to make a counter offer to the seller. The seller in turn can either accept or decline a counter offer from the buyer. The winner of a wish list auction can be greater than one since buyer can accept multiple offerings from multiple sellers. Since buyers are spared of searching duty, sellers are freed from fee charges due to online auction providers, as in all cases of traditional online auctions. Instead, buyers are required to pay for service costs to the online auction provider based on the number of offers transacted in each wish list auction.

### BRIEF DESCRIPTION OF THE DRAWINGS

FIG. 1 is an overall diagram of the system.

FIG. 2 illustrates the elements on a web page for conducting a Wish List auction.

FIG. 3 is a high level flow diagram of the various operations that take place on a buyer's end.

FIG. 4 is a high level flow diagram of the various operations that take place on sellers' end.

FIG. 5 is a program flow diagram of a buyer accepting an offer.

FIG. 6 is a program flow diagram of a buyer making a counter offer.

FIG. 7 is a program flow diagram of a seller respond to a counter offer.

### DESCRIPTION OF PREFERRED EMBODIMENTS

As used herein the following terms have the meaning given below:

“Item”—means goods and services.

“Auction Duration”—means the period between the auction start date and scheduled end date.

“User ID”—means the identification a buyer or seller use during the auction process.

“Seller's Feedback”—means a list of comments made by previous users who have completed transaction with the seller.

“Buyer's Feedback”—means a list of comments made by previous users who have completed transaction with the buyer.

“Number of Offers”—means the total number of actual offers being placed on the item; it is not a counter for tracking potential buyers.

“Sealed Offer”—means an offer that is undisclosed to other sellers.

“Winning Offers”—means the multiple prices that result in transactions between buyer and multiple sellers.

“Time of Entry”—means the time when each offer is made.

“System Controller”—means a computer system or web server that performs various calculations and operations hereinafter described.

“System Operator”—means an individual, company, party, entrepreneur or other entity that operates or is responsible for the computer system or web server that performs various calculations and operations hereinafter described. This entity will act as the liaison between sellers and buyers for conducting an online Buyer's Offer auction.

“Participating Seller”—means anyone within the system network who has actually made a detailed Wish List offer on the auction listing posted by the buyer.

### DETAILED DESCRIPTION OF THE INVENTION

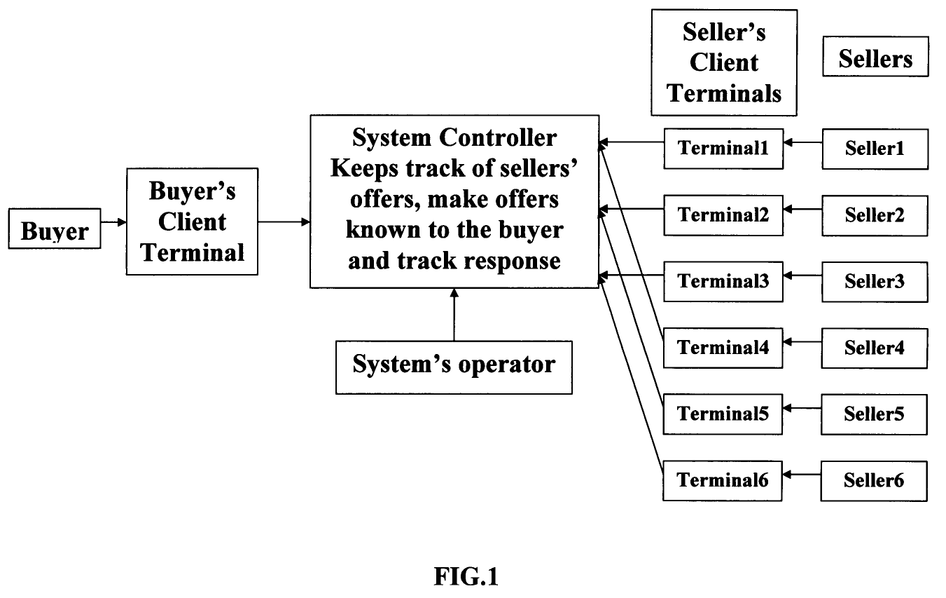

An overall diagram of the invention is shown in FIG. 1. For each wish list auction, the system connects the single buyer with plurality of sellers by means of a system controller. There can only be one buyer for each listing auction; however, the actual numbers of sellers for each auction can be greater or less than six as long as there is at least one seller to participate in such an auction. The system controller can handle almost unrestricted amount of auction listings; at any time, there are plurality of buyers, plurality of sellers, and plurality of auctions within the system network.

The buyer communicates with the controller via the buyer's client terminal, and the sellers 1 to 6 communicate with the controller via sellers' client terminals 1 to 6. Communication is via the Internet. Both the buyer and the sellers' terminals are connected to an ISP (Internet Service Provider) which provides access to the Internet. Correspondingly, controller is also connected to the Internet via an ISP. The drawing lines in FIG. 1 thus represent logical information flow and not physical connections. The buyer and the sellers 1 to 6 are described as being online.

The buyer's client terminal can be a variety of forms of terminals that are obtainable such as computers, laptops, WebTVs, PDAs, information appliances, or any other devices that can be used by the buyer to access the system controller over a network, so the buyer can specify brief description of the item he/she is looking for, communicate with participating sellers, and accept or make counter offers made by participating sellers.

The system controller is one or more network servers running software to keep track the buyer's brief description and auction duration; “intelligently” manage appearance of the auction listing on one or more virtual media such as web sites; and correctly track or process offers posted by sellers who seek to participate in the auction.

The system operator utilizes a client terminal to access and configure the system's controller as is conventional with computer systems and network servers.

The sellers' client terminal 1 to 6 are any of the various forms of terminals that are employed to access web sites such as computers, laptops, thin-client, WebTVs, two-way TV, PDAs, information appliances, or any other devices that sellers may utilize to learn auction listings presented by the controller, to post prices, detailed descriptions, pictures, terms, to communicate with the buyer regarding the auction listing, and be able to make offers, accept or decline counter offers using sellers' client terminals.

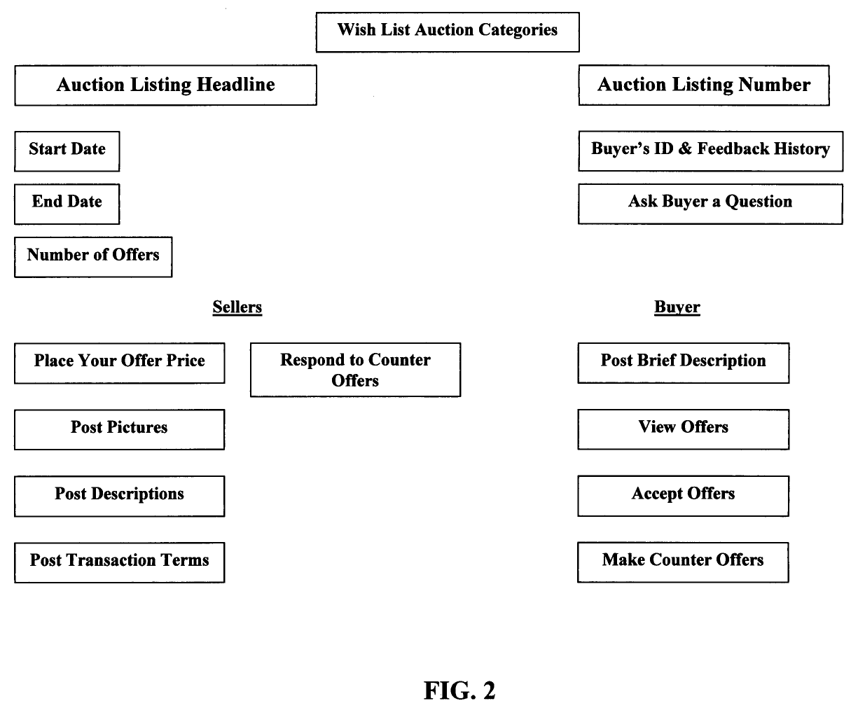

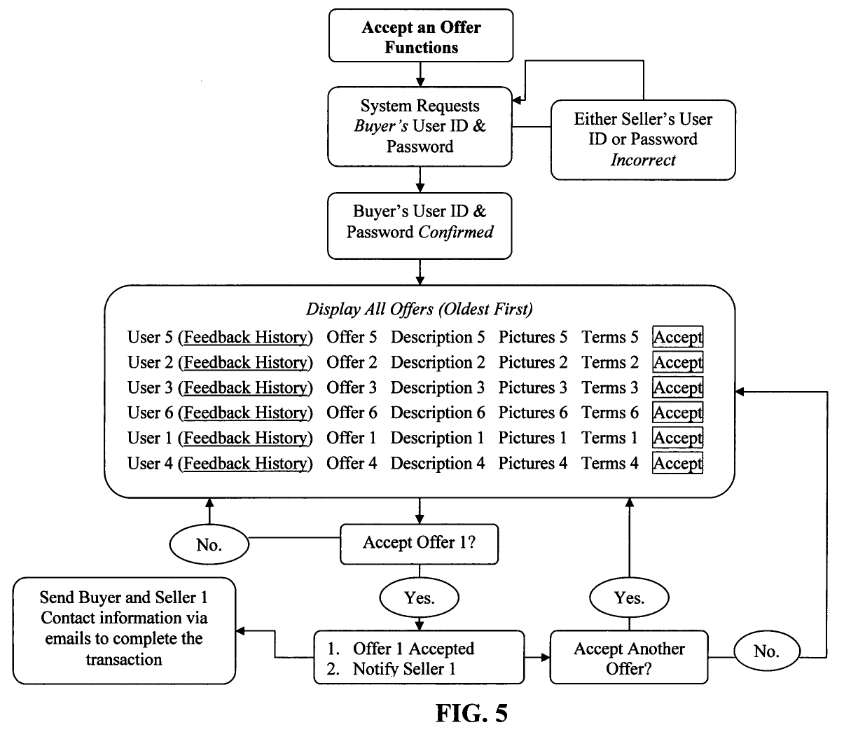

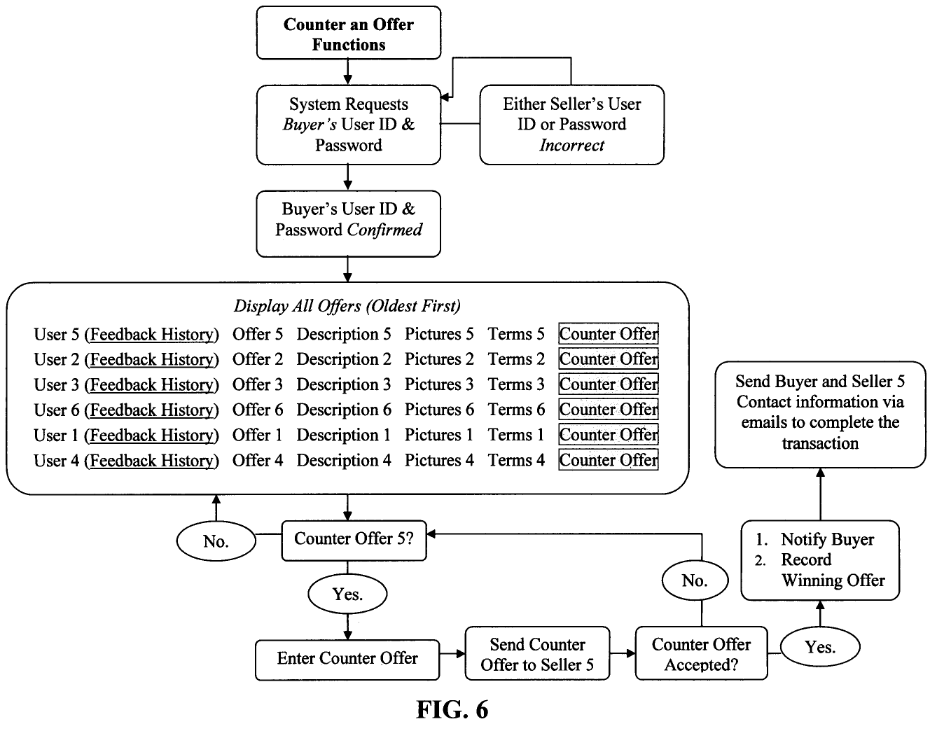

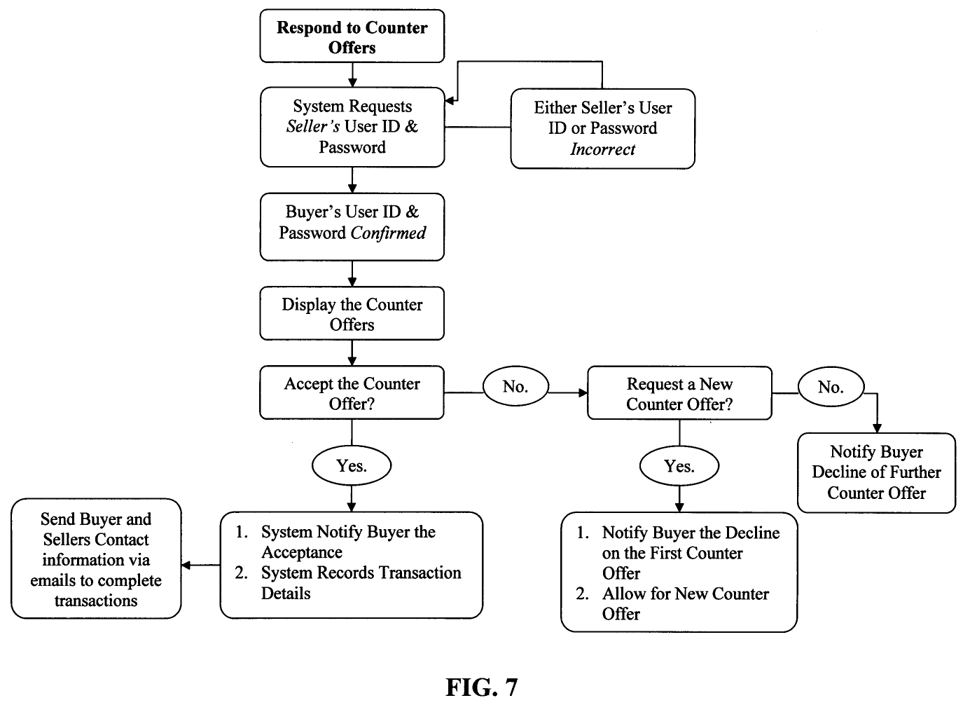

FIG. 2 is a diagram illustrating the elements on a web page which the controller presents to sellers 1 to 6. It is noted that FIG. 2 merely illustrates the fields that are relevant to a preferred embodiment of the invention. FIG. 2 is not meant to illustrate the actual layout of a web page. An actual web page would be laid out in a creative, artistic fashion so as to present a pleasing visual appearance. The artistic nature of the visual appearance of the web page is not relevant to the present invention.
a) A conventional “auction listing categories” is a brief reference of the nature of the item being auctioned. It is relevant to the system's categorization function, but such field is not required for the purpose of system operation.
b) A conventional “auction listing headline” may include a brief description of the item being auctioned. It is relevant to the system's search function used by sellers, but such field is not actually essential to the operation of the system.
c) A conventional “auction listing number” is a series of computer generated numbers which is implemented by the system controller for identification purpose.
d) “Start date” and “end date” determines the auction duration.
e) “Number of offers” in general implies the attractiveness of an auction, and is practical for the seller, the buyers, and the system controller.
f) “Buyer's user ID and Feedbacks” allows potential sellers to determine the worthiness of conducting a transaction with the buyer.
g) “Ask buyer a question” is an option for sellers to communicate with the buyer regarding questions relevant to the item being auctioned prior to making any offers.
h) “Offer price” or “Initial Offer” is the initial price the seller is willing to sell his/her item to the respective buyer.
i) “Detail description” includes but no limited to both the quantitative and qualitative measurements relevant to the item being auctioned.
j) “Pictures” gives potential buyers any applicable visual illustration of the item being offered.
k) “Transaction terms” are the terms set by the sellers regarding shipping and payment options.
l) “Brief description” is an option for buyer in a wish list auction to further specify the dimension and quality of the item he/she is searching for in order for potential sellers to make a better assessment before posting any matching offers.
m) “View Offers” is a function that displays all existing sellers' offers at one time in order for the buyer to gain easy comparisons among prices and qualities of the offerings.
n) “Accept an offer” is one of the three main functions of the said system. It is a function used by the buyer to accept one or more offers placed by participating sellers and to result in one or more transactions prior to the auction deadline. Its detailed functionality and operational process will be discussed later relating to FIG. 5.
o) “Make a counter offer” is the second main function of the said system. It is a function used by the buyer to make counter offers on items posted by participating sellers. Its detailed functionality and operational process will be discussed later relating to FIG. 6.
p) “Respond to counter offer” is the third main function of the said system. Such function is used by sellers after they receive counter offers made by the buyer. If the seller accepts the counter offer, a transaction is resulted between the buyer and that particular seller. If the seller declines the counter offer, a notice will be sent to the buyer. Then the buyer will have the choices to either make a new counter offer or to accept seller's initial offer. Its detailed functionality and operational process will be discussed later relating to FIG. 7.

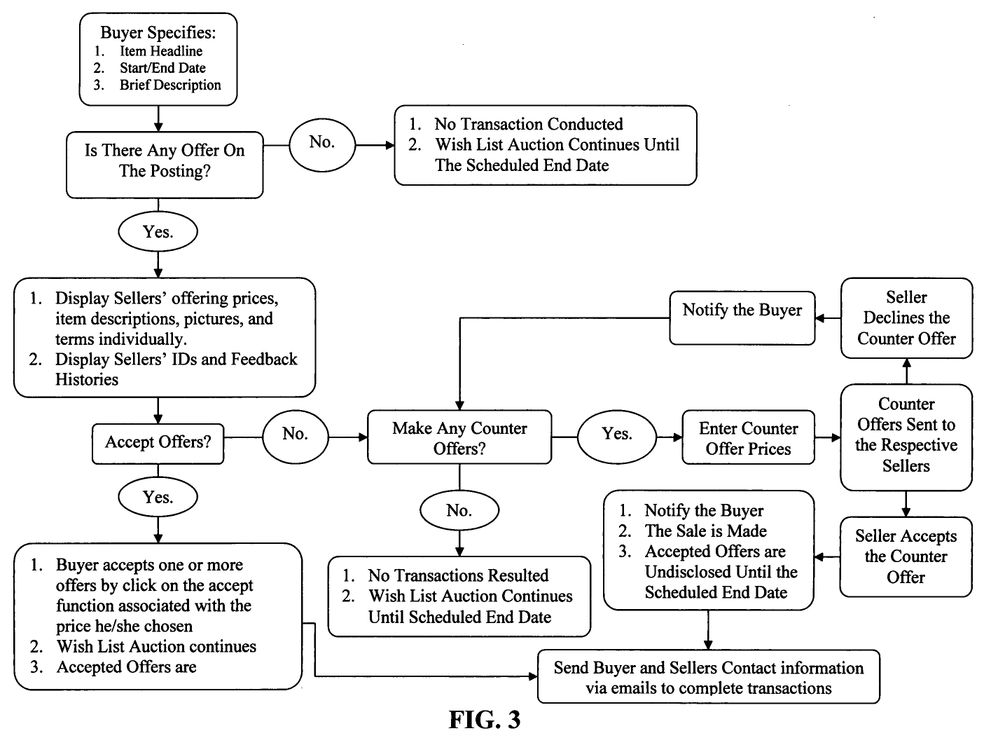

FIG. 3 is an overall diagram of the various operations that take place on a buyer's end. The process begins when a buyer creates a wish list auction listing to seek and purchase a particular item by posting brief item description and auction duration over the web page. For example, the buyer wishes to find a carved ivory cameo using a Wish List auction online. The buyer will specify brief description of the cameo such as its age, size, condition, relief grade, and etc. The buyer will specify the auction duration for 7 days.

Once the auction starts, the system will automatically tracking any offers placed on the item. If there is no offer on the item over the 7 day duration, then the auction will end with no winners. If there is at least one offer on the item, then the system will display to buyer a) all offers posted by participating sellers; b) sort these offers by time of entry; c) seller's user IDs and feedback histories.

Once the buyer has read the detailed descriptions of the items and transaction terms, viewed related pictures, and understood initial offer prices, the buyer will have two options to either accept one or more offers or to make counter offers on the matching items.

If the buyer decides to accept an offer using “accept an offer” function, a successful transaction is conducted, and the system controller will record transaction details automatically. The auction will continue, and the recorded offer will not be disclosed until the end of the auction. The buyer can accept more than one offer in a wish list auction. If the buyer decides to accept another offer, the process repeats itself.

However, if the buyer finds a fitting item but disagree on the seller's initial offer price, the buyer will have the option to make a counter offer. The counter offer will be relayed to the respective seller via the system controller, and if the seller agrees on the counter offer price, a successful transaction is resulted; the system controller will notify the buyer, record transaction details, and keep the information undisclosed until the end of the auction. Contrary, if the seller disagrees on the counter offer price, he/she can decline the counter offer, and such decline will be notified to the buyer. Thus the buyer will have the options to either accept the initial offer price or to make a new counter offer. In a wish list auction, the buyer can make more than one counter offer to each seller's offer as long as the seller permits so.

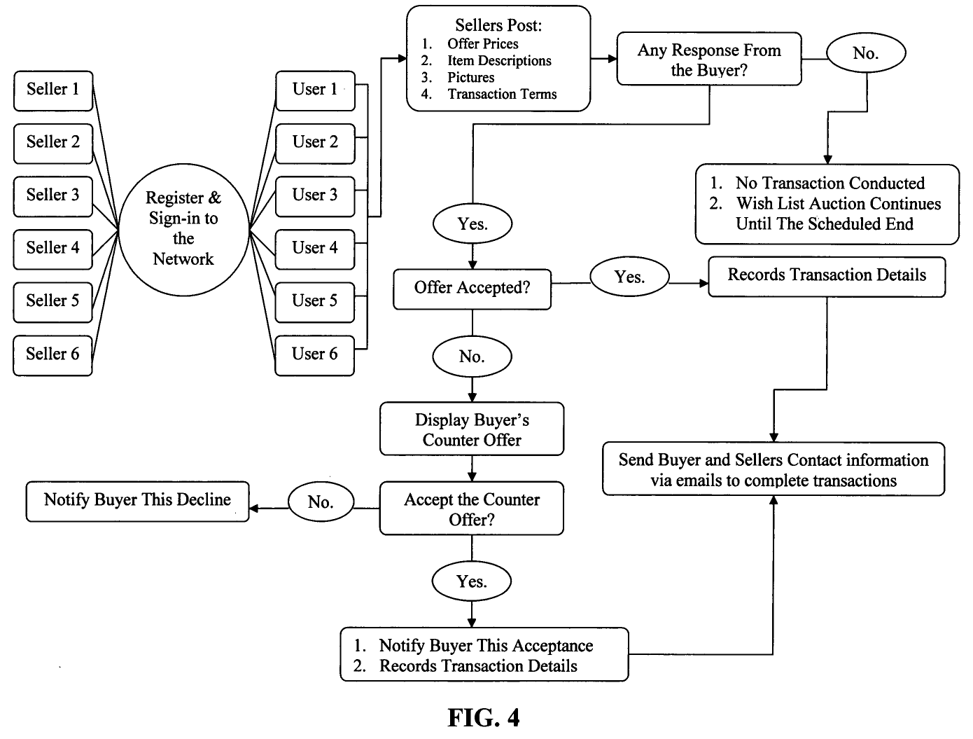

FIG. 4 is an overall diagram of the various operations that take place on sellers end. The process starts with sellers register and sign-in to the online network where the system controller is located. Once their logins are accepted by the system controller, sellers are only identified by their User IDs and feedback histories within such online network. Seller 1 to 6 are now identified as User 1 to 6, and these six users all are interested in the Wish List auction posted by the buyer in FIG. 3 example. Each of them then placed one or more offers on the carved ivory cameo posting. Now User 1 to 6 are the participating sellers on the carved ivory cameo posting.

Any User within the network is now able to view the web page presented by the system controller that contains a list of sellers on the carved ivory cameo. Such list will contain sealed offers identified only by User IDs, and these sealed offers are sorted only by the time of entry.

After sellers posted their respective offers, they will be notified via email by the system controller any new development related to the current auction. If there is no response from the buyer through the entire auction duration, then no transaction has occurred, and auction ends with no winner.

If the buyer accepts an offer, then the respective seller will be notified, and the transaction details are recorded by the system controller but undisclosed until the end of the auction. If the buyer makes a counter offer, then the respective seller is notified with the counter offer price. The seller can either accept the counter offer to conclude a successful transaction or to decline the counter offer for a better offer in a second round counter offering if the buyer decides to.

FIG. 5 is a detail diagram of the operational process of the “accept an offer” function given to the buyer in a Wish List auction. The process begins when the buyer chooses the “accept an offer” function on the auction listing web page. For instance, the buyer in the example of “carved ivory cameo” clicks on the “Accept Offers” link in FIG. 2 where carved ivory cameo offers are posted.

For security purpose, the system controller will request the particular buyer to enter the buyer's User ID and password with the online network. If the buyer's User ID or password does not match the record maintained by the system controller, access to accepting an offer function will be denied. The system controller will re-request the buyer's User ID and password until both match the record maintained by the system controller. It is optional for the system controller to set a maximum trial time for such request for advanced site security.

If the buyer's User ID and password match the record maintained by the system controller, a list of all offers posted on the carved ivory cameo will be displayed to the buyer. The list will be sorted by time of entry from the oldest to newest. The list will contain each offer price, each User ID, associated feedback history, detailed descriptions of the item being offered, pictures, and transaction terms. There will also be an “Accept” function linked with each offer placed on the item. For illustration:

User 5 (Feedback History) $655 Description 5 Pictures 5 Terms 5 Accept
User 2 (Feedback History) $750 Description 2 Pictures 2 Terms 2 Accept
User 3 (Feedback History) $389 Description 3 Pictures 3 Terms 3 Accept
User 6 (Feedback History) $288 Description 6 Pictures 6 Terms 6 Accept
User 1 (Feedback History) $476 Description 1 Pictures 1 Terms 1 Accept
User 4 (Feedback History) $100 Description 4 Pictures 4 Terms 4 Accept

In this example, assuming the buyer is looking for a late 1800's carved ivory cameo with size 2½″ L by 1¾″ W, in excellent condition with no damages, in high relief, front view. After reviewing all details of the offerings, the buyer decides only offers posted by User 5, 2, and 1 fits his/her needs. The buyer finds $476 offered by User 1 is a fair price, thus accepts User 1's offer by using the “Accept” function related to User 1's offer. Once the offer is accepted, User 1 will be notified by the system controller, $476 will be the winning offer on the item, but the price and details are undisclosed until the end of the auction. The buyer will have the option to accept more than one offer if he/she chooses to. The process of accepting an offer will repeat itself. For instance, the buyer can accept $655 posted by User 5 if he/she deems the price also a fair offer for the qualify of the item presented.

FIG. 6 is a detail diagram of the operational process of the “Counter an offer” function given to a buyer in a Wish List auction. The process begins when a buyer chooses the “Counter an offer” function on the auction listing web page. For instance, the buyer in the example of “carved ivory cameo” clicks on the “Make Counter Offers” link in FIG. 2 where carved ivory cameo is listed.

For security purpose, the system controller will request the particular buyer to enter the buyer's User ID and password with the online network. If the buyer's User ID or password does not match the record maintained by the system controller, access to countering an offer function will be denied. The system controller will re-request the buyer's User ID and password until both match the record maintained by the system controller. It is optional for the system controller to set a maximum trial time for such request for advanced site security.

If the buyer's User ID and password match the record maintained by the system controller, a list of all offers posted on the carved ivory cameo will be displayed to the buyer. The list will be sorted by time of entry from the oldest of the newest. The list will be sorted by time of entry from the oldest to newest. The list will contain each offer price, each User ID, associated feedback history, detailed descriptions of the item being offered, pictures, and transaction terms. There will also be a “Counter Offer” function linked with each offer placed on the item.

For illustration revisit the example in FIG. 5. Assume now that the buyer finds only offers posted by User 5 and 2 fits his/her needs, but the buyer believes both items are overpriced by his/her standards.

| | | |
|---|---|---|
| User 5 (Feedback History) | $655 Description | 5 Pictures 5 Terms 5 Counter Offer |
| User 2 (Feedback History) | $750 Description | 2 Pictures 2 Terms 2 Counter Offer |
| User 3 (Feedback History) | $389 Description | 3 Pictures 3 Terms 3 Counter Offer |
| User 6 (Feedback History) | $288 Description | 6 Pictures 6 Terms 6 Counter Offer |
| User 1 (Feedback History) | $476 Description | 1 Pictures 1 Terms 1 Counter Offer |
| User 4 (Feedback History) | $100 Description | 4 Pictures 4 Terms 4 Counter Offer |

Thus, the buyer decides to use the “Counter Offer” functions related to those two offers. The buyer can enter $600 as counter offers for both items. User 5 and 2 will be notified by the system controller of the counter offers. If User 5 finds $600 is a fair counter offer compare to his/her initial offer of $655, User 5 will accept the counter offer, the buyer will be notified, and the price and transaction details will be recorded by the system controller but kept undisclosed until the auction end. If User 2 finds $600 as unfair, he/she can decline the counter offer, and the buyer will be notified of such decline and can make a new counter offer, to say at $650. If User 2 accepts $650 counter offer, the buyer will be notified, and transaction details will be recorded by the system controller but kept undisclosed until the auction end.

FIG. 7 is a detail diagram of the operational process of the “Respond to Counter Offer” function given to sellers in a Wish List auction. The process begins when a seller chooses the “Respond to Counter Offer” function on the auction listing web page. For instance, the buyer in the example of “carved ivory cameo” clicks on the “Respond to Counter Offer” link in FIG. 2 where carved ivory cameo is listed.

For security purpose, the system controller will request the particular buyer to enter the buyer's User ID and password with the online network. If the buyer's User ID or password does not match the record maintained by the system controller, access to countering an offer function will be denied. The system controller will re-request the buyer's User ID and password until both match the record maintained by the system controller. It is optional for the system controller to set a maximum trial time for such request for advanced site security.

If the buyer's User ID and password match the record maintained by the system controller, a history of counter offers posted by the buyer will be displayed to the seller of a particular item. In the FIG. 6 example, assume buyer has made counter offer at $600 to User 5 and 2. User 5 and 2 can view such counter offer and determine whether to accept it or not. For instance, if User 5 agrees on $600 for 1 his/her carved ivory cameo, he/she can accept the counter offer to complete a sale. If User 2 disagrees on pricing with the buyer, he/she can either request a new counter offer or decline any further counter offer. If requesting a new counter offer is selected, buyer will be notified and asked for a higher counter offer. Assume the buyer enters $650, and User 2 agrees; a transaction is resulted. If User 2 declines on further counter offer, the buyer has the options to accept the initial offer or to forgo the item entirely.

Because items offered by individual sellers vary greatly on quality and exactness, buyer will often receive diverse offers tailored to the quality of the item presented. In a wish list auction, there is no flat price for all participating items; instead, pricings are determined on individual basis. Although not all items will be qualified to match the buyer's needs, a wish list auction delivers more options to a buyer than otherwise possible in traditional auction methods, without time being wasted in searching.

In return, auction costs are charged based on the number of offers accepted in a wish list auction and are paid by the buyer of the auction. By taking the burden of auction costs away from sellers, they are more willing to present higher quality items at lower prices in meeting the buyer's demand.

Moreover, since all offers are sealed from other sellers during a wish list auction, sellers in order to complete sales are expected to enter close to their best offers to compete against other participating sellers. For the cost of auction fees, the buyer is more likely to discover enticing offers with larger supply of matching items compete in the same auction listing.

In Summary, wish list auction serves the needed relief for buyers in minimizing search costs while providing the opportunity to eliminate auction costs for sellers in online auctions.

It should be understood that while various embodiments of the invention have been described, those skilled in art could make various changes in form, detail, and design without departing from the principle, spirit, and scope of the invention described herein. Applicant's invention is limited only by the scope of the appended claims.

1. A method of conducting a sealed offer auction, the method comprising: a) buyers post ad-like listings in seeking desired items; b) buyers receiving multiple offerings from multiple sellers; c) all offers contains detailed information about the respective items; d) the auction has a scheduled deadline provided by the auction system provider and selected by the buyer of the item; e) the buyer can either accept an offer or make a counter offer; f) the seller has the option to accept or decline a counter offer; g) all offer details are sealed from other sellers; h) The winner of the auction can be greater than one based on the number of offers accepted by the buyer; i) buyer is responsible for paying auction fees to the online auction provider; j) sellers are not charged with any fee in a wish list auction.

2. A method as in claim 1 wherein said auction is an online auction.

3. A method as in claim 1 wherein said auction is for goods and services.

4. “Auction System Provider” in claim 1 is an online auction service provider or an online auction host.

5. An online system for conducting a seal offer auction, the system comprising:
A controller;
Buyer's terminal which communicates with said controller whereby buyer can enter and transmit, prior to the beginning of an auction, a listing for said at least one item, a listing comprising the headline and brief description of the item the buyer is searching for;
Web pages which display said auction listing;
A plurality of individual seller terminals which communicate with said controller whereby said plurality of individual sellers can post offer details, accept or decline to said computer server counter offers from the buyer for the auctioning items prior to the auction end;
Said controller displays all offerings in a sealed manner, with said plurality of individual sellers' user IDs on the item according to time of entry to all users;
Said buyer can communicate with said controller through buyer's terminal whereby said buyer can either accept or make counter offer to said plurality of individual sellers;
Winners of said auction listing whose offers are accepted by said buyer during the auction duration;
A system time tracker which operates on said computer server to track offering details posted by said plurality of individual sellers according to time of entry of said offers;
An email system which operates on said computer server to notify said buyer and said plurality of individual sellers any offer acceptances, counter offers, counter offer acceptances, and counter offer declines related to said auction listing; and the said email system allows communications between said buyer and said plurality of individual sellers regarding said auction listing;
A database system which operates on said computer server to store information or data such as user IDs, passwords, email addresses, contact information, credit card numbers, banking account numbers, feedback histories, and all information related to auction listing, processing, and ending results;
A check out system which operates on said computer server to allow said plurality of individual sellers enter and calculate total transaction amount and deliver said plurality of individual sellers contact information via email to said buyer; and the said check out system is programmed to display said winners contact information to said buyer upon auction closing.

6. The system recited in claim 5 operating in accordance with said specified and limited time period whereby offers for a particular listing are only accepted for said specified and limited time period.

7. The system recited in claim 5 wherein said buyer terminal is terminal connected to the Internet.

8. The system recited in claim 5 wherein said plurality of individual sellers terminals are terminals connected to the Internet.

9. The system recited in claim 5 wherein said controller comprises a server.

10. The system recited in claim 5 wherein said buyer terminal and said plurality of individual potential seller terminals communicate with said controller via the Internet.
